(19) United States
(12) Patent Application Publication
(10) Pub. No.: US 2025/0149741 A1
(43) Pub. Date: May 8, 2025

(54) ALL-SOLID-STATE RECHARGEABLE BATTERY

(71) Applicant: SAMSUNG SDI CO., LTD., Yongin-si (KR)

(72) Inventors: MINSUK LEE, Yongin-si (KR); Jaewon Kim, Yongin-si (KR); Jin-Woo Kim, Yongin-si (KR); Young Gyoon Ryu, Yongin-si (KR)

(21) Appl. No.: 18/822,623

(22) Filed: Sep. 3, 2024

(30) Foreign Application Priority Data
Nov. 2, 2023 (KR) 10-2023-0150318

(51) Int. Cl. H01M 50/474; H01M 4/02; H01M 10/0525; H01M 10/0585; H01M 50/477

(52) U.S. Cl. CPC H01M 50/474; H01M 10/0525; H01M 10/0585; H01M 50/477; H01M 2004/021; H01M 2004/028

(57) ABSTRACT

An all-solid-state rechargeable battery including a negative electrode; a solid electrolyte layer stacked on the negative electrode; a positive electrode including a positive active material layer on a positive electrode current collector and stacked on the solid electrolyte layer; and a gasket inserted at an edge to overlap the positive active material layer and between the positive active material layer and the solid electrolyte layer, wherein the positive active material layer includes a high-density area corresponding to the gasket and compressed by an intrusion of the gasket, and a low-density area inside the high-density area.

### CROSS-REFERENCE TO RELATED APPLICATION

This application claims priority to and the benefit of Korean Patent Application No. 10-2023-0150318 filed at the Korean Intellectual Property Office on Nov. 2, 2023, the entire contents of which are incorporated herein by reference.

### BACKGROUND

### 1. Field

The present disclosure relates to an all-solid-state rechargeable battery.

### 2. Description of the Related Art

Recently, in response to industry demands, development of batteries with high energy density and safety is being actively conducted. For example, lithium ion batteries are being commercialized not only in information-related devices and communication devices, but also in the automotive field. In the automotive field, safety is particularly important because it may be related to life.

The above information disclosed in this Background section is for enhancement of understanding of the background of the present disclosure, and therefore, it may contain information that does not constitute prior art.

### SUMMARY

Embodiments are directed to an all-solid-state rechargeable battery including a negative electrode; a solid electrolyte layer stacked on the negative electrode; a positive electrode, including a positive active material layer on a positive electrode current collector, stacked on the solid electrolyte layer; and a gasket inserted at an edge to overlap the positive active material layer and between the positive active material layer and the solid electrolyte layer, wherein the positive active material layer includes a high-density area corresponding to the gasket and compressed by an intrusion of the gasket, and a low-density area inside the high-density area.

The positive electrode current collector may include a low-intensity area corresponding to the high-density area, and a high-intensity area inside the low-intensity area.

The high-density area may have a density of about 3.4 g/cm³ to about 3.6 g/cm³, and the low-density area may have a density of about 3.2 g/cm³ to about 3.4 g/cm³.

An end of the positive electrode may align with an end of the gasket, and an end of the solid electrolyte layer may protrude farther outward than the end of the positive electrode and the end of the gasket by a protrusion width.

The positive active material layer and the gasket may form a plane on the solid electrolyte layer.

The positive active material layer and the gasket may form a stepped structure.

The gasket may penetrate the solid electrolyte layer.

An amount of penetration of the gasket may be about 20% or less of a thickness of the gasket.

The gasket may form a stepped structure with the positive active material layer, and a reverse stepped structure with the solid electrolyte layer.

The gasket may include an oxide.

A width of the gasket may be greater than 0 and less than about 5 mm, and a thickness of the gasket may be greater than 0 and less than about 10 μm.

Embodiments are directed to a manufacturing method of an all-solid-state rechargeable battery, the manufacturing method including pressing a positive electrode in which a positive active material layer is on a positive electrode current collector with a first roll press; transferring a gasket to a surface of the positive active material layer with a second roll press; punching the positive electrode to which the gasket is transferred with a flat plate; stacking a negative electrode on a solid electrolyte layer; stacking the solid electrolyte layer on the positive active material layer and the gasket; and pressing the solid electrolyte layer with a third roll press.

The first roll press may pressurize the positive active material layer with 50% of a total pressurization increasing a first adhesion between the positive active material layer and the gasket to be greater than a second adhesion between the gasket and a carrier film.

The second roll press may pressurize a first area of the positive active material layer corresponding to the gasket to a high density, and pressurizes a second area, which is inside the first area, to a lower density than the first area.

The second roll press may pressurize a first response area of the positive electrode current collector to low intensity, and pressurize a second response area, which is inside the first response area, to a higher intensity than the first response area.

The third roll press may align ends of the positive electrode and the gasket with each other, and may cause an end of the solid electrolyte layer to protrude farther outward than the ends of the positive electrode and the gasket by a protrusion width.

The third roll press may form the positive active material layer and the gasket to be on the same plane on the solid electrolyte layer.

The third roll press may further form the gasket to protrude beyond the surface of the positive active material layer on the solid electrolyte layer and to penetrate the solid electrolyte layer.

### BRIEF DESCRIPTION OF THE DRAWINGS

Features will become apparent to those of skill in the art by describing in detail exemplary embodiments with reference to the attached drawings in which:

FIG. 1 is a cross-sectional view showing an all-solid-state rechargeable battery according to an embodiment.

FIG. 2 is a cross-sectional view showing a formation of a lithium metal layer of an all-solid-state rechargeable battery according to an embodiment.

FIG. 3 is a cross-sectional view showing an all-solid-state rechargeable battery according to a first embodiment of the present disclosure.

FIG. 4 is an exploded view of the all-solid-state rechargeable battery of FIG. 3.

FIG. 5 is an enlarged cross-sectional view showing a portion of the all-solid-state rechargeable battery of FIG. 3.

FIG. 6 is a cross-sectional view showing an all-solid-state rechargeable battery according to a second embodiment of the present disclosure.

FIG. 7 is a flowchart showing a manufacturing method of an all-solid-state rechargeable battery according to an embodiment.

FIG. 8 is a cross-sectional view of a state in which a gasket is transferred to a positive electrode and a carrier film is not removed.

FIG. 9A is a cross-sectional view of a state in which a gasket is transferred to a positive electrode.

FIG. 9B is a cross-sectional view of a state in which a positive electrode transferred at FIG. 9A is punched out and a carrier film is removed.

FIG. 10 is a cross-sectional view of a state in which a negative electrode is stacked on a solid electrolyte layer.

FIG. 11 is a cross-sectional view of a state in which a gasket-transferred positive electrode is punched out and stacked on a solid electrolyte layer.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In addition, unless explicitly described to the contrary, the word “comprise,” and variations such as “comprises” or “comprising,” should be understood to imply the inclusion of stated elements but not the exclusion of any other elements.

In the drawings, when an element is referred to as being “directly on” another element, there are no intervening elements present.

In addition, “layer” herein includes not only a shape formed on the whole surface when viewed from a plan view, but also a shape formed on a partial surface. In the specification, A and/or B and A or B are not exclusive terms, and indicate A, B, or both A and B.

Positive Electrode for an all-Solid-State Rechargeable Battery

One embodiment may provide a positive electrode for an all-solid-state rechargeable battery including a current collector and a positive active material layer on the current collector, wherein the positive active material layer may include a positive active material, a sulfide solid electrolyte, a fluorinated resin binder, and a vanadium oxide.

The positive electrode for the all-solid-state rechargeable battery may be manufactured by applying a positive electrode composition including a positive active material, a sulfide solid electrolyte, a fluorinated resin binder, and a vanadium oxide to a current collector, drying them, and rolling them.

The positive electrode composition may have a strong basicity due to residual lithium such as LiOH or other components, which may result in gelation or agglomeration of the fluorinated resin binder. However, in an implementation, by adding a vanadium oxide, gelation of the fluorinated resin binder may be suppressed and processability may be secured by maintaining the viscosity of the positive electrode composition. In addition, since there may be no need to use a neutralizing agent or the like, degradation of the sulfide solid electrolytes by the neutralizing agent may be prevented, and performance of the all-solid-state rechargeable battery may be improved accordingly.

### Vanadium Oxide

The vanadium oxide may be a component insoluble in the solvent of the positive electrode composition, controlling the strong basicity of the positive electrode composition to prevent gelation of the fluorinated resin binder, while simultaneously suppressing the degradation of the sulfide solid electrolyte, and thereby improving the ion conductivity of the positive electrode. The vanadium oxide may control pH through physical or chemical reactions with —OH groups in the positive electrode composition in the strong base state and thus suppress gelation of the fluorinated resin binder. Compared to other transition metal oxides such as titanium oxide or tungsten oxide, the vanadium oxide may have a more excellent ability to control basicity and suppress gelation of the fluorinated resin binder and may have low reactivity to the sulfide solid electrolytes, and the ion conductivity of the solid-state rechargeable batteries may be improved and the overall performance may be improved by suppressing the degradation of the sulfide solid electrolytes.

The vanadium oxide may include, e.g., V₂O₃, VO₂, V₂O₄, V₂O₅, or combinations thereof. The vanadium oxide may be included in an amount of about 0.01 wt % to about 5 wt %, based on a total weight of the positive active material layer, e.g., about 0.05 wt % to about 5 wt %, about 0.1 wt % to about 5 wt %, about 0.5 wt % to about 5 wt %, or about 0.5 wt % to about 3 wt %. Maintaining the vanadium oxide in the above ranges may help ensure that the viscosity of the positive electrode composition may be appropriately maintained without deterioration of capacity, thereby improving processability and improving the ion conductivity of the positive electrode.

In an implementation, the positive electrode composition may be coated on the current collector in a state in which the vanadium oxide may be dispersed by adding the vanadium oxide to the positive electrode composition, so the vanadium oxide may be dispersed in the manufactured positive active material layer. In an implementation, the vanadium oxide may be coated on the surface of the positive active material or the sulfide solid electrolyte.

In an implementation, the vanadium oxide may be a pentavalent vanadium (V) oxide, in which case a melting point of the vanadium oxide may be equal to or less than about 1000° C., e.g., about 600° C. to about 800° C., or about 650° C. to about 690° C. The pentavalent vanadium oxide may be excellent at suppressing the gelation of the fluorinated resin binder in the positive electrode and may be advantageous for improving overall performance of the battery.

The vanadium oxide may be in a particle form and its average particle diameter D50 may be about 10 nm to about 10 μm, e.g., about 10 nm to about 5 μm, about 10 nm to about 3 μm, about 50 nm to about 1 μm, about 50 nm to about 500 nm, or about 500 nm to about 1 μm. The vanadium oxide with these physical properties, e.g., having particle diameters in the above ranges, may be suitable for being input to the positive electrode composition, and may effectively suppress gelation of the positive electrode composition without adversely affecting the positive electrode. If a particle diameter of the vanadium oxide is too small, it may not be dispersed properly in the positive electrode, blocking the passage of electrons and ions, which may degrade battery performance, or may not sufficiently suppress gelation of the binder. If the particle diameter of the vanadium oxide is too large, it may block the passage of electrons and ions, thereby degrading the performance of the battery.

### Fluorinated Resin Binder

The fluorinated resin binder may be a suitable resin binder including fluorine. In an implementation, it may include polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polytetrafluoroethylene, or combinations thereof.

A weight average molecular weight of the fluorinated resin binder may be about 50 kDa to about 5,000 kDa, or about 100 kDa to about 2000 kDa. A glass transition temperature of the fluorinated resin binder may be equal to or less than about −10° C., and a melting point may be equal to or greater than about 100° C. A melting viscosity of the fluorinated resin binder may be about 10 kP to about 50 kP. In an implementation, the fluorinated resin binder may be in the form of particles, and an average particle diameter may be about 50 nm to about 200 μm. The fluorinated resin binder with these physical properties may have excellent adhesion, and if a small amount thereof is put into the positive electrode composition it may increase durability of the battery without adversely affecting battery performance.

The fluorinated resin binder may be included in an amount of about 0.1 wt % to about 10 wt %, based on a total weight of the positive active material layer, e.g., in the amount of about 0.1 wt % to about 8 wt %, about 0.1 wt % to about 6 wt %, about 0.1 wt % to about 5 wt %, about 0.5 wt % to about 4 wt %, or about 1 wt % to about 3 wt %. Maintaining the fluorinated resin binder within the above content ranges may help ensure that it may have excellent adhesion without adversely affecting the positive electrode.

### Positive Active Material

The positive active material may be a suitable material used in all-solid-state rechargeable batteries. In an implementation, the positive active material may be a compound allowing reversible intercalation and deintercalation of lithium, and may include a compound expressed as one of following formulae.

LiₐA_{1-b}X_{b}D′₂(0.90≤a≤1.8,0≤b≤0.5);

LiₐA_{1-b}X_{b}O_{2-c}D′_{c}(0.90≤a≤1.8,0≤b≤0.5,0≤c≤0.05);

LiₐE_{1-b}X_{b}O_{2-c}D′_{c}(0.90≤a≤1.8,0≤b≤0.5,0≤c≤0.05);

LiₐE_{2-b}X₆O_{4-c}D′_{c}(0.90≤a≤1.8,0≤b≤0.5,0≤c≤0.05);

LiₐNi_{1-b-c}Co_{b}X_{c}D′_{α}(0.90≤a≤1.8,0≤b>0.5,0≤c≤0.5,0<α≤2);

LiₐNi_{1-b-c}Co_{b}X_{c}O_{2-α}T_{α}(0.90<a≤1.8,0≤b≥0.5,0≤0.05,0<α≤2);

LiₐNi_{1-b-c}CO_{b}X_{c}O_{2-α}T₂(0.90≤a≤1.8,0≤b≤0.5,0≤c≤0.05,0<α≤2);

LiₐNi_{1-b-c}Mn_{b}X_{c}D′ₐ(0.90<a≤1.8,0≤b≤0.5,0≤c≤0.05,0<α<2);

LiₐNi_{1-b-c}Mn_{b}X_{c}O_{2-α}T_{α}(0.90≤a≤1.8,0≤b≤0.5,0≤c≤0.05,0<α<2);

LiₐNi_{1-b-c}Mn_{b}X_{c}O₂₋ₐT₂(0.90≤a≥1.8,0≤b≤0.5,0≤c≤0.05,0<α<2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}G_{b}O₂(0.90≤a≤1.8,0.001≤b≤0.1);

LiₐMn₂GbO₄(0.90≤a≤1.8,0.001≤b≤0.1);

LiₐMn_{1-g}G_{g}PO₄(0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2);

LiₐFePO₄(0.90≤a≤1.8).

Regarding the formulae, A may be, e.g., Ni, Co, Mn, or combinations thereof; X may be, e.g., Al, Ni, Co, Mn, Cr, Fe, Mg, Sr, V, rare earth elements, or combinations thereof; D′ may be, e.g., O, F, S, P, or combinations thereof; E may be, e.g., Co, Mn, and combinations thereof; T may be, e.g., F, S, P, or combinations thereof; G may be, e.g., Al, Cr, Mn, Fe, Mg, La, Ce, Sr, V, or combinations thereof; Q may be, e.g., Ti, Mo, Mn, or combinations thereof; Z may be, e.g., Cr, V, Fe, Sc, Y, or combinations thereof, and J may be, e.g., V, Cr, Mn, Co, Ni, Cu, or combinations thereof.

The positive active material may be, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or a lithium iron phosphate oxide (LFP).

The positive active material may include a lithium nickel oxide expressed in Formula 1, a lithium cobalt oxide expressed in Formula 2, a lithium iron phosphate compound expressed in Formula 3, or combinations thereof.

Liₐ₁Niₓ₁M¹_{y1}M²_{1-x1-y1}O₂ [Chemical Formula 1]

In Formula 1, 0.9≤a1≤1.8, 0.3≤x1≤1, 0≤y1≤0.7, and M¹ and M² may each independently be, e.g., Al, B, Ba, Ca, Ce, Co, Cr, Cu, F, Fe, Mg, Mn, Mo, Nb, P, S, Si, Sr, Ti, V, W, or Zr.

Liₐ₂Coₓ₂M³₁₋ₓ₂O₂ [Chemical Formula 2]

In Formula 2, 0.95a2≤1.8, 0.65x2≤1, and M³ may be, e.g., Al, B, Ba, Ca, Ce, Cr, Cu, F, Fe, Mg, Mn, Mo, Nb, P, S, Si, Sr, Ti, V, W, or Zr.

Liₐ₃Fe^{x3}M⁴₁₋ₓ₃PO₄ [Chemical Formula 3]

In Formula 3, 0.9≤a3≤1.8, 0.65x3≤1, and M⁴ may be, e.g., Al, B, Ba, Ca, Ce, Co, Cr, Cu, F, Fe, Mg, Mn, Mo, Nb, P, S, Si, Sr, Ti, V, W, or Zr.

The average particle diameter D50 of the positive active material may be about 1 μm to about 25 μm, e.g., about 3 μm to about 25 μm, about 5 μm to about 25 μm, about 5 μm to about 20 μm, about 8 μm to about 20 μm, or about 10 μm to about 18 μm. The positive active material having a particle diameter in the above ranges may be mixed with other components in the positive active material layer and may realize high capacity and high energy density.

The positive active material may have a secondary particle form made by agglomerating primary particles or may have a single particle form. The positive active material may have a spherical shape or another shape that is similar to the spherical shape, or may be a polyhedron or an amorphous shape.

### Sulfide Solid Electrolyte

The sulfide solid electrolyte may include, e.g., Li₂S—P₂S₅, Li₂S—P₂S₅—LiX (X may be a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers, and Z may be Ge, Zn, or Ga), Li₂S—GeS₂, Li₂S—SiS₂—Li₃PO₄, Li₂S—SiS₂—LiₚMO_{q} (p and q are integers, and M may be P, Si, Ge, B, Al, Ga, or In), or combinations thereof.

The sulfide solid electrolyte may be obtained by, e.g., mixing Li₂S and P₂S₅ with a mole ratio of about 50:50 to about 90:10 or a mole ratio of about 50:50 to about 80:20 and selectively performing heat treatment. Maintaining a mixing ratio in the above ranges may help ensure that the sulfide solid electrolyte with excellent ion conductivity may be prepared. The ion conductivity may be further increased by including other components such as SiS₂, GeS₂, or B₂S₃.

A mechanical milling or a solution method may be applied as a method for mixing sulfur-including materials and producing a sulfide solid electrolyte. Mechanical milling may be a method for inserting starting materials and a ball mill into a reactor and strongly agitating them to particulate the starting materials and mix them. If using the solution method, the solid electrolyte may be obtained as a precipitate by mixing the starting materials in a solvent. If heat treatment is performed after mixing, the solid electrolyte crystals may become more solid and the ion conductivity may be improved. In an implementation, the sulfide solid electrolyte may be prepared by mixing sulfur-including materials and heat treating them at least twice, and in this way, the sulfide solid electrolyte with high ion conductivity and robustness may be prepared.

In an implementation, the sulfide solid electrolyte particle may include an argyrodite-type sulfide. The argyrodite-type sulfide may be expressed by, e.g., the formula of LiₐM_{b}P_{c}S_{d}Aₑ (a, b, c, d, and e may be equal to or greater than 0 and equal to or less than 12, M may be Ge, Sn, Si, or combinations thereof, and A may be F, Cl, Br, or I), and, e.g., may be expressed by the formula of Li₇₋ₓPS₆₋ₓAₓ (x may be equal to or greater than 0.2 and equal to or less than 1.8, and A may be F, Cl, Br, or I). The argyrodite-type sulfide may be Li₃PS₄, Li₂P₃S₁₁, Li—PS₆, Li₆PS₅Cl, Li₆PS₅Br, Li_{5.8}PS_{4.8}Cl_{1.2}, Li_{6.2}PS_{5.2}Br_{0.8}, etc.

The sulfide solid electrolyte particles including the argyrodite-type sulfide may have high ion conductivity that is close to the range of about 10⁻⁴ S/cm to about 10⁻² S/cm, which may be the ion conductivity of some liquid electrolytes at ambient temperature, and may form an close bond between the positive active material and the solid electrolyte without causing a decrease in the ion conductivity, and may furthermore form an close interface between an electrode layer and a solid electrolyte layer. The all-solid-state battery including the same may have improved battery performance such as rate capability, Coulombic efficiency, and cycle-life characteristics.

The argyrodite-type sulfide solid electrolyte may be prepared, e.g., by mixing lithium sulfide and phosphorus sulfide, and optionally lithium halide. Heat treatment may be performed after mixing them. The heat treatment may include, e.g., at least two heat treatments.

The average particle diameter D50 of the sulfide solid electrolyte particle according to an embodiment may be equal to or less than about 5.0 μm, e.g., about 0.1 μm to about 5.0 μm, about 0.1 μm to about 4.0 μm, about 0.1 μm to about 3.0 μm, about 0.5 μm to about 2.0 μm, or about 0.1 μm to about 1.5 μm. The sulfide solid electrolyte particles may be small particles with the average particle diameter D50 of about 0.1 μm to about 1.0 μm or large particles with the average particle diameter D50 of about 1.5 μm to about 5.0 μm depending on the positions or purposes for which they are used. The sulfide solid electrolyte particles having this particle size range may effectively penetrate among the solid particles in the battery, and may have excellent contact with the electrode active material and connectivity among the solid electrolyte particles. The average particle diameter of the sulfide solid electrolyte particles may be measured using a microscope image, and, e.g., a particle size distribution may be obtained by measuring the size of about twenty particles in a scanning electron microscope image, and the diameter D50 may be calculated therefrom.

A content of the solid electrolyte in the positive electrode for an all-solid-state battery may be about 0.5 wt % to about 35 wt %, e.g., about 1 wt % to about 35 wt %, about 5 wt % to about 30 wt %, about 8 wt % to about 25 wt %, or about 10 wt % to about 20 wt %. This may be the content based on the total weight of the components in the positive electrode, and in an implementation, may be the content based on the total weight of the positive active material layer.

In an implementation, the positive active material layer may include about 50 wt % to about 99.35 wt % of the positive active material, about 0.5 wt % to about 35 wt % of the sulfide solid electrolyte, about 0.1 wt % to about 10 wt % of the fluorinated resin binder, and about 0.05 wt % to about 5 wt % of the vanadium oxide based on a total weight of the positive active material layer. Maintaining the above-noted content ranges may help ensure that the positive electrode for an all-solid-state rechargeable battery may realize high capacity and high ion conductivity, may maintain high adhesion, and may maintain the viscosity of the positive electrode composition at an appropriate level, thereby improving processability.

### Conductive Material

The positive active material layer may further include a conductive material. The conductive material may provide conductivity to the electrode, e.g., it may include carbon materials such as natural graphite, artificial graphite, carbon black, acetylene black, Ketjen black, carbon fibers, carbon nanotubes, etc.; metal materials including copper, nickel, aluminum, and silver having a metal powder form or a metal fiber form; conductive polymers such as polyphenylene derivatives; or combinations thereof.

The conductive material may be included in an amount of about 0.1 wt % to about 5 wt %, or about 0.1 wt % to about 3 wt %, based on the entire weight of the respective components of the positive electrode for an all-solid-state battery or the entire weight of the positive active material layer. Maintaining the conductive material in the above ranges may help ensure that the conductive material may not degrade the battery performance but may improve the electrical conductivity.

If the positive active material layer further includes a conductive material, the positive active material layer may include about 45 wt % to about 99.25 wt % of the positive active material, about 0.5 wt % to about 35 wt % of the sulfide solid electrolyte, about 0.1 wt % to about 10 wt % of the fluorinated resin binder, about 0.05 wt % to about 5 wt % of the vanadium oxide, and about 0.1 wt % to about 5 wt % of the conductive material based on a total weight of the positive active material layer.

The positive electrode for a lithium rechargeable battery may further include an oxide inorganic solid electrolyte in addition to the above-described solid electrolyte. The oxide inorganic solid electrolyte may include, e.g., Li₁₊ₓTi₂₋ₓAl (PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} (PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<₂, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M=Te, Nb, or Zr; and x is an integer of 1 to 10), or combinations thereof.

### All-Solid-State Rechargeable Battery

The embodiment may provide the all-solid-state rechargeable battery including the above-described positive electrode and the negative electrode and the solid electrolyte layer between the positive electrode and the negative electrode. The all-solid-state rechargeable battery may be referred to as an all-solid-state battery, or a solid lithium rechargeable battery.

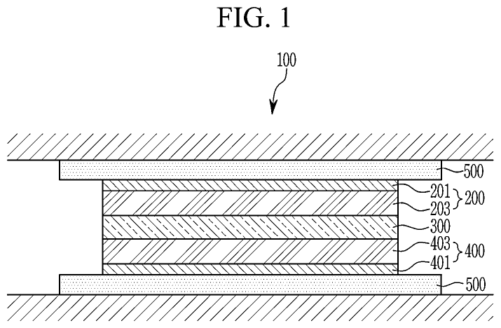

FIG. 1 shows a cross-sectional view of an all-solid-state rechargeable battery according to an embodiment. Referring to FIG. 1, the all-solid-state rechargeable battery 100 may have a structure in which an electrode assembly in which a negative electrode 400 including a negative electrode current collector 401 and a negative active material layer 403, a solid electrolyte layer 300, and a positive electrode 200 including a positive active material layer 203 and a positive electrode current collector 201 are stacked may be accommodated in a case such as a pouch.

The all-solid-state rechargeable battery 100 may further include an elasticity layer 500 on at least one external side of the positive electrode 200 or the negative electrode 400. In an implementation, as illustrated in FIG. 1, one electrode assembly including the negative electrode 400, the solid electrolyte layer 300, and the positive electrode 200, and the all-solid-state battery may be manufactured by stacking at least two electrode assemblies.

### Negative Electrode

The negative electrode for an all-all-solid-state battery may, e.g., include a current collector and a negative active material layer on the current collector. The negative active material layer may include a negative active material, and may further include a binder, a conductive material, or a solid electrolyte.

The negative active material may include a material for reversibly intercalating/deintercalating lithium ions, a lithium metal, alloys of the lithium metal, a material doped to the lithium and de-doped from the same, or a transition metal oxide.

The material for reversibly intercalating/deintercalating lithium ions may include, e.g., crystalline carbon, amorphous carbon, or a combination thereof as a carbon negative active material. The crystalline carbon may be non-shaped, or sheet-, flake-, spherical-, or fiber-shaped natural graphite or artificial graphite, and the amorphous carbon may be a soft carbon, a hard carbon, a mesophase pitch carbonized product, calcined coke, or the like.

The alloy of the lithium metal may use an alloy of lithium and at least one metal, e.g., Na, K, Rb, Cs, Fr, Be, Mg, Ca, Sr, Si, Sb, Pb, In, Zn, Ba, Ra, Ge, Al, and Sn.

The material capable of doping/de-doping lithium may be a Si negative electrode active material or an Sn negative electrode active material. The Si negative electrode active material may include silicon, a silicon-carbon composite, SiOₓ (0<x<2), a Si-Q alloy (wherein Q may be an alkali metal, an alkaline-earth metal, a Group 13 element, a Group 14 element, a Group 15 element, a Group 16 element, a transition metal, a rare earth element, or a combination thereof, but not Si) and the Sn negative electrode active material may include Sn, SnO₂, Sn—R alloy (wherein R may be an alkali metal, an alkaline-earth metal, a Group 13 element, a Group 14 element, a Group 15 element, a Group 16 element, a transition metal, a rare earth element, or a combination thereof, but not Sn), and at least one of these materials may be mixed with SiO2. The elements Q and R may be, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or combinations thereof.

The silicon-carbon composite may be, e.g., a silicon-carbon composite including a core including crystalline carbon and silicon particles and an amorphous carbon coating layer on the surface of the core. The crystalline carbon may be artificial graphite, natural graphite, or combinations thereof. The amorphous carbon precursor may be a coal pitch, mesophase pitch, petroleum pitch, coal oil, petroleum heavy oil, or a polymer resin such as a phenol resin, a furan resin, or a polyimide resin. The content of silicon may be about 10 wt % to about 50 wt %, based on a total weight of the silicon-carbon composite. The content of the crystalline carbon may be about 10 wt % to about 70 wt %, based on the total weight of the silicon-carbon composite, and the content of the amorphous carbon may be about 20 wt % to about 40 wt %, based on the total weight of the silicon-carbon composite. A thickness of the amorphous carbon coating layer may be about 5 nm to about 100 nm.

The average particle diameter D50 of the silicon particle may be about 10 nm to about 20 μm, e.g., about 10 nm to about 500 nm. The silicon particles may exist in an oxidized form, and an atomic content ratio of Si:O in the silicon particles indicating a degree of oxidation may be about 99:1 to about 33:66. The silicon particle may be particles of SiOₓ, and the range of x in SiOₓ in this case may be greater than 0 and less than about 2. The average particle diameter D50 may be measured using a particle size analyzer using a laser diffraction method and may represent a diameter of particles whose cumulative volume is 50 volume % in a particle size distribution

The Si negative active material or the Sn negative active material may be mixed with the carbon negative active material. A mixing ratio of the carbon negative active material with one of the Si negative active material and the Sn negative active material may be about 1:99 to about 90:10 as the weight ratio.

The negative active material may be included in an amount of about 95 wt % to about 99 wt %, based on the total weight of the negative active material layer on the negative active material layer.

In an implementation, the negative active material layer may further include a binder, and may optionally further include a conductive material. The content of the binder on the negative active material layer may be about 1 wt % to about 5 wt %, based on the total weight of the negative active material layer. If further including a conductive material, the negative active material layer may include about 90 wt % to about 98 wt % of the negative active material, about 1 wt % to about 5 wt % of the binder, and about 1 wt % to about 5 wt % of the conductive material, based on a total weight of the negative active material layer.

The binder may serve to help adhere the negative active material particles to each other and may also help adhere the negative active material to the current collector. The binder may include a non-water-soluble binder, a water-soluble binder, or a combination thereof.

In an implementation, the water-insoluble binder may include polyvinyl chloride, carboxylated polyvinyl chloride, polyvinyl fluoride, an ethylene oxide-including polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or combinations thereof.

The water-soluble binder may include a rubber binder or a polymer resin binder. The rubber binder may be, e.g., a styrene-butadiene rubber, an acrylated styrene-butadiene rubber, an acrylonitrile-butadiene rubber, an acrylic rubber, a butyl rubber, a fluororubber, and combinations thereof. The polymer resin binder may be, e.g., a polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or combinations thereof.

If using the water-soluble binder as the negative electrode binder, a thickener for providing viscosity may be used in combination, and the thickener may, e.g., include a cellulose compound. The cellulose compound may include, e.g., carboxymethyl cellulose, hydroxypropylmethyl cellulose, methyl cellulose, alkali metal salts thereof, or combinations thereof. Na, K, or Li may be used as the alkali metal. The used amount of the thickener may be about 0.1 parts by weight to about 3 parts by weight, based on 100 parts by weight of the negative active material.

The conductive material may be used to provide conductivity to the electrode, and may e.g., include carbon materials such as natural graphite, artificial graphite, carbon black, acetylene black, Ketjen black, carbon fibers, or carbon nanotubes; metal materials including copper, nickel, aluminum, and silver having a metal powder shape or a metal fiber shape; conductive polymers such as a polyphenylene derivative; or mixtures thereof.

The negative current collector may include, e.g., a copper foil, a nickel foil, a stainless steel foil, a titanium foil, a nickel foam, a copper foam, a polymer substrate coated with a conductive metal, or combinations thereof.

In an implementation, the negative electrode for an all-solid-state battery may be a precipitation-type negative electrode. The precipitation-type negative electrode may be a negative electrode which has no negative active material during the assembly of a battery but in which a lithium metal and the like are precipitated during the charge of the battery and serve as a negative active material.

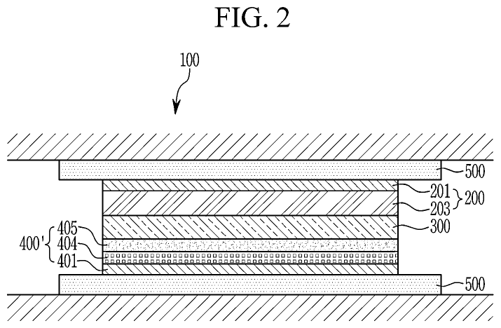

FIG. 2 shows a cross-sectional view on an all-solid-state rechargeable battery including a precipitation-type negative electrode according to an embodiment. Referring to FIG. 2, a precipitation-type negative electrode 400′ may include a negative electrode current collector 401 and a negative electrode coating layer 405 on the negative electrode current collector 401. The all-solid-state battery having the precipitation-type negative electrode 400′ may start to be initially charged in absence of a negative active material, and a lithium metal with high-density and the like may be precipitated between the negative electrode current collector 401 and the negative electrode coating layer 405 during the charge and may form a lithium metal layer 404 which may serve as the negative active material. Accordingly, the precipitation-type negative electrode 400′ in the all-solid-state battery which is charged at least once may include the negative electrode current collector 401, the lithium metal layer 404 on the current collector, and the negative electrode coating layer 405 on the lithium metal layer 404. The lithium metal layer 404 may represent a layer in which the lithium metal and the like are precipitated during the charge of the battery, and may be referred to as a metal layer or a negative active material layer.

The negative electrode coating layer 405 may include a metal, a carbon material, or a combination thereof functioning as a catalyst. The metal may include, e.g., gold, platinum, palladium, silicon silver, aluminum, bismuth, tin, zinc, or a combination thereof and may be composed of one selected therefrom or an alloy of more than one. If the metal is present in a particle form, an average particle diameter D50 thereof may be less than or equal to about 4 μm, e.g., about 10 nm to about 4 μm.

The carbon material may be, e.g., crystalline carbon, amorphous carbon, or combinations thereof. The crystalline carbon may be, e.g., natural graphite, artificial graphite, mesophase carbon microbeads, or combinations thereof. The amorphous carbon may be, e.g., carbon black, activated carbon, acetylene black, denka black, Ketjen black, or combinations thereof.

If the negative electrode coating layer 405 includes the metal and the carbon material, the metal and the carbon material may be, e.g., mixed in the weight ratio of about 1:10 to about 2:1. The precipitation of the lithium metal may be effectively performed, and characteristics of the all-solid-state battery may be improved. The negative electrode coating layer 405 may include, e.g., a carbon material on which a catalyst metal may be supported or may include a mixture of metal particles and carbon material particles.

The negative electrode coating layer 405 may include, e.g., metal and amorphous carbon, and precipitation of lithium metal may be effectively performed. The negative electrode coating layer 405 may further include a binder, and the binder may be a conductive binder. The negative electrode coating layer 405 may further include general additives such as a filler, a dispersant, and an ion conductive material.

The thickness of the negative electrode coating layer 405 may, e.g., be about 100 nm to about 20 μm, about 500 nm to about 10 μm, or about 1 μm to about 5 μm.

The precipitation-type negative electrode 400′ may further include, e.g., a thin film on a surface of the current collector, e.g., between the current collector and the negative electrode coating layer. The thin film may include an element for forming an alloy with lithium. The element for forming an alloy with lithium may be, e.g., gold, silver, zinc, tin, indium, silicon, aluminum, bismuth, and the like, and may be configured with one of them or may be configured with many types of alloys. The thin film may further planarize the precipitation shape of the lithium metal layer 404 and may further improve the characteristics of the all-solid-state battery. The thin film may be formed by, e.g., a vacuum deposition method, a sputtering method, a plating method, etc. The thickness of the thin film may, e.g., be about 1 nm to about 500 nm.

### Solid Electrolyte Layer

The solid electrolyte layer 300 may include a sulfide solid electrolyte and an oxide solid electrolyte.

In an implementation, the solid electrolyte included in the positive electrode 200 and the solid electrolyte included in the solid electrolyte layer 300 may include the same compound or different compounds. In an implementation, if the positive electrode 200 and the solid electrolyte layer 300 include an argyrodite-type sulfide solid electrolyte, overall performance of the all-solid-state rechargeable battery may be improved. In an implementation, if the positive electrode 200 and the solid electrolyte layer 300 include the aforementioned coated solid electrolyte, the all-solid-state rechargeable battery may implement excellent initial efficiency and lifespan characteristics while implementing high capacity and high energy density.

The average particle diameter D50 of the solid electrolyte included in the positive electrode 200 may be less than the average particle diameter D50 of the solid electrolyte included in the solid electrolyte layer 300. In this case, overall performance may be improved by increasing the mobility of lithium ions while maximizing the energy density of the all-solid-state battery. In an implementation, the average particle diameter D50 of the solid electrolyte included in the positive electrode 200 may be about 0.1 μm to about 1.0 μm or about 0.1 μm to about 0.8 μm, and the average particle diameter D50 of the solid electrolyte included in the solid electrolyte layer 300 may be about 1.5 μm to about 5.0 μm, about 2.0 μm to about 4.0 μm, or about 2.5 μm to about 3.5 μm. Maintaining the particle size in the above ranges may help ensure that the energy density of the all-solid-state rechargeable battery may be maximized while the transfer of lithium ions may be facilitated, so that resistance may be suppressed, and thus the overall performance of the all-solid-state rechargeable battery may be improved. The average particle diameter D50 of the solid electrolyte may be measured through a particle size analyzer using a laser diffraction method. Alternatively, about twenty particles may be arbitrarily selected from a micrograph of a scanning electron microscope or the like, the particle size may be measured, the particle size distribution may be obtained, and the D50 value may be calculated.

The solid electrolyte layer may further include a binder in addition to the solid electrolyte. The binder may include a styrene butadiene rubber, polytetrafluoroethylene, polyvinylidene fluoride, polyethylene, an acrylate polymer, or combinations thereof. The acrylate polymer may be, e.g., butyl acrylate, polyacrylate, polymethacrylate, or a combination thereof.

The solid electrolyte layer may be formed by adding a solid electrolyte to a binder solution, coating it on a base film, and drying it. The solvent of the binder solution may be isobutyl isobutyrate, xylene, toluene, benzene, hexane, or a combination thereof.

The thickness of the solid electrolyte layer may be, e.g., about 10 μm to about 150 μm. The solid electrolyte layer may further include an alkali metal salt and/or an ionic liquid and/or a conductive polymer.

The alkali metal salt may be, e.g., lithium salt. The concentration of the lithium salt in the solid electrolyte layer may be greater than or equal to about 1 M, e.g., about 1M to about 4M. The lithium salt may improve ion conductivity by enhancing the mobility of lithium ions in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LiODFB), lithium difluoro (oxalato)borate (LiDFOB), lithium bis(trifluoro methanesulfonyl)imide, LiTFSI, LiN(SO₂CF₃)₂, lithium bis(fluorosulfonyl)imide, LiFSI, LiN(SO₂F)₂, LiCF₃SO₃, LiAsF₆, LiSbF₆, LiClO₄, or mixtures thereof.

The lithium salt may be an imide salt, and, e.g., the imide lithium salt may include lithium bis(trifluoro methanesulfonyl)imide (LiTFSI), LiN(SO₂CF₃)₂, lithium bis(fluorosulfonyl)imide, LiFSI, or LiN (SO₂F)₂. The lithium salt may maintain or improve ion conductivity by appropriately maintaining chemical reactivity with the ionic liquid.

The ionic liquid has a melting point below ambient temperature, so it may be a salt or a ambient-temperature molten salt in a liquid state at the room temperature and composed of ions.

The ionic liquid may be a compound including at least one cation, e.g., a) ammonium, pyrrolidinium, pyridinium, pyrimidinium, imidazolium, piperidinium, pyrazolium, oxazolium, pyridazinium, phosphonium, sulfonium, triazolium, or a mixture thereof, and at least one anion, e.g., b) BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂) (CF₃SO₂)N—, or (CF₃SO₂)₂N—.

The ionic liquid may be, e.g., N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis (trifluoromethylsulfonyl)amide.

The weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. Maintaining the solid electrolyte layer in the above ranges may maintain or improve ion conductivity by improving the electrochemical contact area with the electrode. Accordingly, the energy density, discharge capacity, rate capability, etc. of the solid-state battery may be improved.

The all-solid-state battery may be a unit battery with a structure of positive electrode/solid electrolyte layer/negative electrode, a bi-cell with a structure of positive electrode/solid electrolyte layer/negative electrode/solid electrolyte layer/positive electrode, or a battery repeatedly stacking the unit batteries.

The shape of the all-solid-state battery may be, e.g., a coin type, a button type, a sheet type, a stack type, a cylindrical shape, a flat type, or the like. The all-solid-state battery may be applied to a large-sized battery used in an electric vehicle or the like. In an implementation, the all-solid-state battery may also be used in a hybrid vehicle such as a plug-in hybrid electric vehicle (PHEV). It may be used in a field requiring a large amount of power storage, e.g., electric bicycles or power tools.

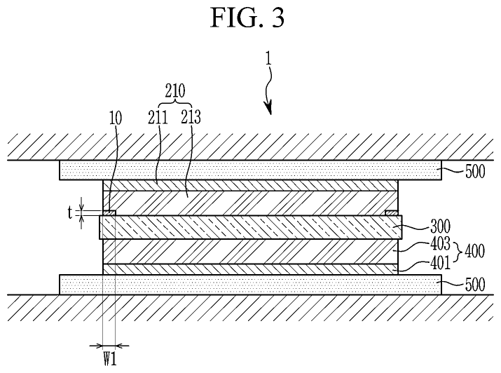

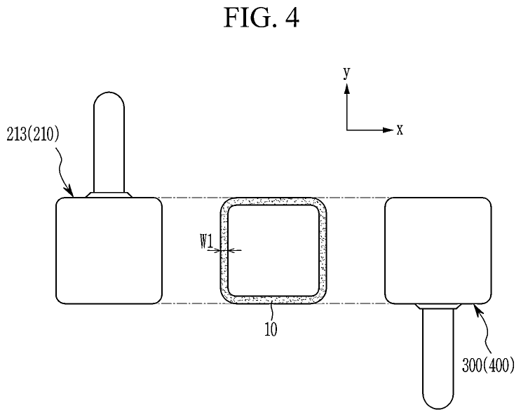

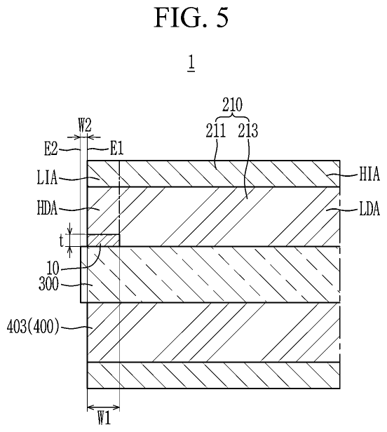

FIG. 3 is a cross-sectional view showing an all-solid-state rechargeable battery according to a first embodiment of the present disclosure. FIG. 4 is an exploded view showing an all-solid-state rechargeable battery in FIG. 3. FIG. 5 is an enlarged cross-sectional view showing a portion of FIG. 3.

Referring to FIG. 3 to FIG. 5, the all-solid-state rechargeable battery 1 according to the first embodiment includes a negative electrode 400, a solid electrolyte layer 300, a positive electrode 210, an elasticity layer 500, and a gasket 10. The all-solid-state rechargeable battery 1 of the first embodiment may be called a mono-cell consisting of a single-sided electrode plate. In an implementation, the gasket 10 may be applied with the same structure in a bi-cell.

The positive electrode 210 having a cross-section may include a positive active material layer 213 produced by a slurry coating a positive active material on one surface of a positive electrode current collector 211 or bonding a solvent-free active material. The negative electrode 400 may include a negative active material layer 403 on a negative electrode current collector 401. The solid electrolyte layer 300 may be formed as a film by directly coating a solid electrolyte film on the negative active material layer 403.

An elasticity layer 500 may be on at least one side of the positive electrode 210 or the negative electrode 400, and, in an implementation, it may be provided on both sides. The elasticity layer 500 may provide flatness between the negative electrode 400 and the solid electrolyte layer 300 and flatness between the solid electrolyte layer 300 and the positive electrode 210 through a buffering force and an elastic force in response to an Li precipitation and dissociation of the negative electrode 400 during charging and discharging.

The gasket 10 may be positioned on an edge between the positive active material layer 213 and the solid electrolyte layer 300, enabling a uniform pressurization of the solid electrolyte layer 300 to the positive electrode 210 and the negative electrode 400. If the negative electrode 400 is an Li ion precipitation type, Li ions passing through the solid electrolyte layer 300 from the positive electrode 210 may be precipitated on the negative electrode 400 when charging, and may be dissociated and moved to the positive electrode 210 when discharging.

If charging, the Li ions may be precipitated at the negative electrode 400, and the cell volume expands. Also, if pressure is not applied to the cell, the lithium precipitation may be non-uniform in a free state, the charging and discharging may proceed, non-uniformity of the lithium precipitation may be amplified, and the solid electrolyte layer 300 may be partially broken, which may cause a short circuit

The gasket 10 may be configured to enable the uniform pressurization of the solid electrolyte layer 300 while preventing the movement of lithium ions outside the positive active material layer 213. For this, the gasket 10 may have an ionic conductivity of zero. For example, the gasket may be an insulating gasket formed of an insulating material.

The solid electrolyte layer 300 may be a freestanding layer, and in this case, it may contain a non-woven fabric. In an implementation, the gasket 10 may be formed by coating a binder on polypropylene (PP) or polypropylene non-woven fabric.

The gasket 10 may be interposed on the outside between the solid electrolyte layer 300 and the positive electrode 210, and may allow the pressurization uniformity of the solid electrolyte layer 300 to be increased through changes in the thickness, density, and intensity of the positive electrode 210 in the pressurization process. The gasket 10 may be formed of oxide and may have a predetermined thickness t and a width W1.

The change in thickness of the positive electrode 210 due to the pressurization process appears on the positive active material layer 213. By the pressurization process, the positive active material layer 213 may include a high-density area HDA and a low-density area LDA by the gasket 10. In an implementation, the high-density area HDA may be expressed by a density of about 3.4 g/cm³ to about 3.6 g/cm³, and the low-density area LDA may be expressed by a density of about 3.2 g/cm³ to about 3.4 g/cm³.

The high-density area HDA may be compressed by an intrusion corresponding, e.g., equal, to the width W1 of the gasket 10 and corresponding, e.g., equal, to the thickness t of the gasket 10. The low-density area LDA may not correspond to the width W1 of the gasket 10 and may be provided inside the high-density area HDA. That is, the high-density area HDA and the low-density area LDA may be set to correspond to a boundary line by the width W1 of the gasket 10.

Additionally, the change in the thickness of the positive electrode 210 due to the pressurization process may change the intensity of the positive electrode current collector 211. By the pressurization process, the positive electrode current collector 211 may include a low-intensity area LIA and a high-intensity area HIA by the gasket 10. As an example, the low-intensity area LIA may be displayed as about 800 nm to about 1500 nm, and the high-intensity area HIA may be displayed as about 150 nm to about 800 nm.

The low-intensity area LIA may form a smooth surface corresponding to, e.g., overlapping, the width W1 of the gasket 10, that is, the high-density area HDA. The high-intensity area HIA may form a rough surface corresponding to the outside of the width W1 of the gasket 10, that is, the low-density area LDA, and may be inside the low-intensity area LIA.

The all-solid-state rechargeable battery 1 according to an embodiment may include a first end E1 corresponding to, e.g., overlapping, the ends of the positive electrode 210 and the gasket 10, which may align with each other, and a second end E2 corresponding with, e.g., overlapping, the end of the solid electrolyte layer 300 which may protrude outwardly by a protrusion width W2 more than the first end E1. In this case, the positive electrode 210 and the negative electrode 400 may be the same size.

The solid electrolyte layer 300 may be the same size as the negative electrode 400 before the pressurization process, and may become larger than the negative electrode 400 by stretching after the pressurization process. That is, the solid electrolyte layer 300 may become larger on one side than the negative electrode 400 by the protrusion width W2, so when considering both sides of the entire width of the solid electrolyte layer 300, it may become twice the protrusion width W2 (W2*2) as large.

The gasket 10 may be formed of an oxide layer of a thin film having the width W1 and the thickness t of the gasket 10. In an implementation, the width W1 may be greater than 0 and less than about 5 mm (0<W1<5 mm). The thickness t may be greater than 0 and less than about 10 μm (0<t<10 μm).

If the width W1 of the gasket 10 is zero (W1=0), an insulation layer may not be formed on the positive electrode 210, and if the width W1 of the gasket 10 is greater than 5 mm (W1>5 mm), the performance of the positive active material layer 213 may be reduced, thereby causing the capacity to deteriorate. In addition, if the thickness t of the gasket 10 is more than 10 μm, too large a step may be created on the positive active material layer 213, which may be unsuitable for uniform pressurization of the solid electrolyte layer 300.

Compared to the negative electrode 400, the protruding portion of the solid electrolyte layer 300 may be zero before the pressurization process (W2=0), and during a roll press process, it may protrude by side stretching and may be less than about 1 mm (0≤W2≤1 mm). Due to the protruding portion of the solid electrolyte layer 300, physical contact between the negative electrode 400 and the positive electrode 210 may be precluded. The protruding portion may be derived from a pressurizing process and may not break or fall off easily.

In this way, while the sizes of the positive electrode 210 and the negative electrode 400 may be the same, the width W of the gasket 10 may functionally make an NP ratio, e.g., a ratio of the size negative electrode 400 and the size of the positive electrode 210, greater than 1.0 (NP ratio>1). Accordingly, an electrical short circuit between the negative electrode 400 and the positive electrode 210 may be suppressed.

Due to the intrusion of the gasket 10, the positive active material layer 213 and the gasket 10 may form a coplanar surface on the solid electrolyte layer 300 side. The positive active material layer 213 and the gasket 10 may form a stepped structure. For example, as illustrated in FIG. 3, the boundary between the gasket 10 and the positive active material layer 213 may form a stepped structure.

Therefore, even if the gasket 10 is applied, the pressure between the solid electrolyte layer 300 and the positive active material layer 213, where the gasket 10 is not positioned, and the pressure between the solid electrolyte layer 300 and the gasket 10, where the gasket 10 is positioned, may achieve equilibrium.

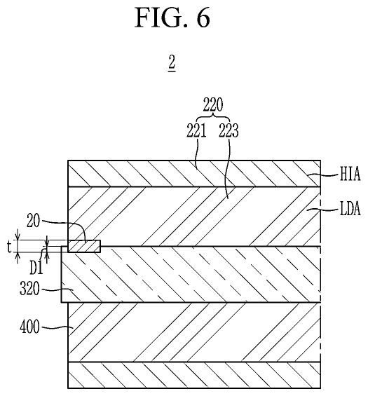

FIG. 6 is a cross-sectional view showing an all-solid-state rechargeable battery according to a second embodiment of the present disclosure. Referring to FIG. 6, in the all-solid-state rechargeable battery 2 of the second embodiment, the gasket 20 may be positioned on the outside between the solid electrolyte layer 320 and the positive electrode 220 to allow the thickness change, density change, and roughness change of the positive electrode 220 and the solid electrolyte layer 320 in the pressurization process to increase the pressurization uniformity of the solid electrolyte layer 320.

The positive electrode 220 may include a positive electrode current collector 221 and a positive active material layer 223. The gasket 20 may penetrate into the positive active material layer 223 and the solid electrolyte layer 320. In this case, the penetration amount D1 of the gasket 20 into the solid electrolyte layer 320 may be within about 20%, e.g., about 20% or less, of the thickness t of the gasket 20 (D1≤0.2t). The gasket 20 may form a stepped structure with the positive active material layer 223 and a reverse stepped structure with the solid electrolyte layer 320. For example, as illustrated in FIG. 6, the boundary between the gasket 20 and the positive active material layer 223 may form a stepped structure and the boundary between the gasket 20 and the solid electrolyte layer 320 may form a reverse stepped structure.

Therefore, even if the gasket 20 is applied, the pressure between the solid electrolyte layer 320 and the positive active material layer 223, where the gasket 20 is not positioned, and the pressure between the solid electrolyte layer 320 and the gasket 20, where the gasket 20 is positioned, may achieve equilibrium.

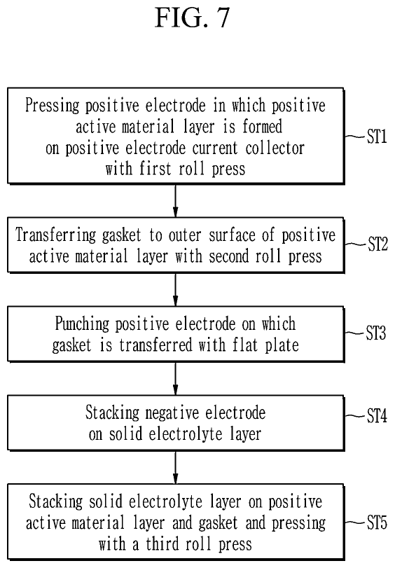

FIG. 7 is a flowchart showing a manufacturing method of an all-solid-state rechargeable battery according to an embodiment. For convenience, the all-solid-state rechargeable battery 1 of the first embodiment is taken as an example.

Referring to FIG. 7, the manufacturing method of the all-solid-state rechargeable battery according to an embodiment may include a first step ST1, a second step ST2, a third step ST3, a fourth step ST4, a fifth step ST5. In the first step ST1, the positive electrode 210 in which the positive active material layer 213 may be formed on the positive electrode current collector 211 may be pressed with a first roll press.

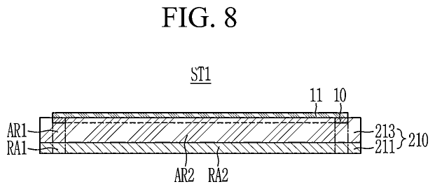

FIG. 8 is a cross-sectional view of a state in which a gasket is transferred to a positive electrode and a carrier film is not removed. Referring to FIG. 7 and FIG. 8, the gasket 10 may be treated while adhered to the carrier film 11, and may be supplied to the positive active material layer 213 together with a carrier film 11 and then transferred.

In the first step ST1, the positive active material layer 213 may be pressurized with 50% of the total pressurization of the entire process for the positive active material layer 213. At this time, a first adhesive force formed between the positive active material layer 213 and the gasket 10 may increase more significantly than, e.g., may be greater than, a second adhesive force formed between the gasket 10 and the carrier film 11.

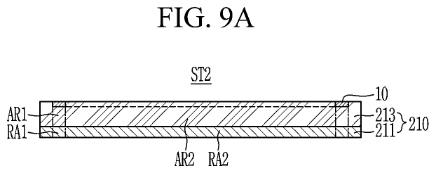

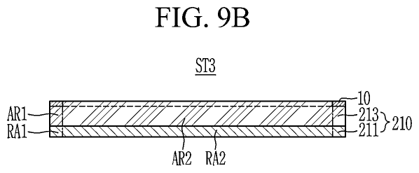

FIG. 9A is a cross-sectional view of a state in which a gasket is transferred to a positive electrode. FIG. 9B is a cross-sectional view of a state in which a positive electrode transferred at FIG. 9A may be punched and a carrier film may be removed. Referring to FIG. 7, and FIG. 9A, in the second step ST2, the gasket 10 may be transferred to the outer surface of the positive active material layer 213 by a second roll press.

In the second step ST2, in the positive active material layer 213, a first area AR1 corresponding to, e.g., overlapping, the gasket 10 may be pressurized to the high-density area HDA, e.g., pressurized to the density of the high-density area HDA, and a second area AR2 set inside the first area AR1 may be pressurized to the low-density area LDA, e.g., pressurized to the density of the low-density area LDA, lower density than the first area AR1.

Also, in the second step ST2, a first response area RA1 corresponding to, e.g., overlapping, the first area AR1 of the positive electrode current collector 211 may be pressurized to a low-intensity area (a smooth surface) LIA, and a second response area RA2, which may be set inside the first response area RA1, may be pressurized to a high-intensity area (a rough surface) HIA, higher intensity than the first response area RA1.

Referring to FIG. 7 and FIG. 9B, in the third step ST3, the positive electrode 210 on which the gasket 10 may be transferred may be punched out by a pressing plate. In the positive electrode 210, the positive active material layer 213 may include the first area AR1 and the second area AR2, and the positive electrode current collector 211 may include the first response area RA1 and the second response area RA2.

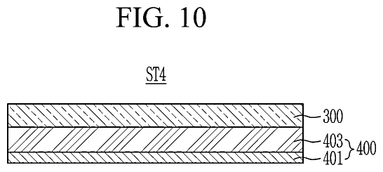

FIG. 10 is a cross-sectional view of a state in which a negative electrode is stacked on a solid electrolyte layer. Referring to FIG. 7 and FIG. 10, in the fourth step ST4, the negative electrode 400 may be stacked on the solid electrolyte layer 300. The stack of the solid electrolyte layer 300 and the negative electrode 400 may therefore be formed. In an implementation, the outer edges of the solid electrolyte layer 300 and the negative electrode 400 may remain aligned.

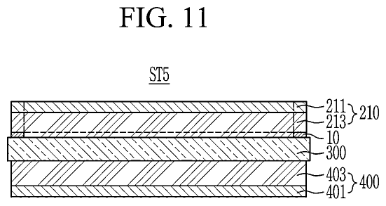

FIG. 11 is a cross-sectional view of a state in which a gasket-transferred positive electrode may be punched out and stacked on a solid electrolyte layer. Referring to FIG. 7 and FIG. 11, in the fifth step ST5, the solid electrolyte layer 300 may be stacked on the positive active material layer 213 and the gasket 10 and may be pressed by a third roll press. In an implementation, the solid electrolyte layer 300 may be stretched and protrude farther than the negative electrode 400 by a protrusion width W2 on one side.

In an implementation, through the pressurization process, in the fifth step ST5, the first end E1 corresponding to the ends of the positive electrode 210 and the gasket 10, which may be aligned with each other, and the second end E2 corresponding with the end of the solid electrolyte layer 300 may further protrude outward from the first end E1 by the protrusion width W2 (see FIG. 5).

In the fifth step ST5, the gasket 10 may penetrate the positive active material layer 213, and the positive active material layer 213 and the gasket 10 may be formed on the same plane on the solid electrolyte layer 300 (referring to FIG. 5 and FIG. 11).

Therefore, even if the gasket 10 is applied, the pressure between the solid electrolyte layer 300 and the positive active material layer 213, where the gasket 10 is not positioned, and the pressure between the solid electrolyte layer 300 and the gasket 10 where the gasket 10 is positioned may be in equilibrium.

If applying the all-solid-state rechargeable battery 2 of the second embodiment, in the fifth step ST5, the gasket 20 may penetrate into the positive active material layer 223, and on the solid electrolyte layer 320 side, the gasket 20 may protrude farther than the surface of the positive active material layer 223 and thereby penetrate into the solid electrolyte layer 320 (see FIG. 6).

Therefore, even if the gasket 20 is applied, the pressure between the solid electrolyte layer 320 and the positive active material layer 223, where the gasket 20 is not positioned, and the pressure between the solid electrolyte layer 320 and the gasket 20, where the gasket 20 is positioned, may achieve equilibrium.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples

The Examples and Comparative Examples prepared using the all-solid-state rechargeable battery according to the manufacturing method of the embodiment will be compared and described with reference to Table 1.

TABLE 1

| | Gasket | | | | | | | | |
|---|---|---|---|---|---|---|---|---|---|
| | | Power | | Binder | | | Evaluation | | |
| | | | Size | PVDF- | | Width | | Initial | Short |
| | | | (D50, | HFP | Thickness | (W1, | Pressurization | capacity | circuit |
| | Applicability | Composition | μm) | (wt. %) | (μm) | mm) | uniformity | (mAh/g) | position |
| First | Application | Al2O3 | 0.3 | 5 | 1 | 2 | ⊙ | 181 | >300 |
| experimental | | | | | | | | | |
| example | | | | | | | | | |
| Second | Application | SiO2 | 0.3 | 5 | 1 | 2 | ⊙ | 180 | >300 |
| experimental | | | | | | | | | |
| example | | | | | | | | | |
| Third | Application | ZrO2 | 0.3 | 5 | 1 | 2 | ⊙ | 182 | >300 |
| experimental | | | | | | | | | |
| example | | | | | | | | | |
| Fourth | Application | TiO2 | 0.3 | 5 | 1 | 2 | ⊙ | 179 | >300 |
| experimental | | | | | | | | | |
| example | | | | | | | | | |
| Fifth | Application | Al2O3 | 0.3 | 5 | 2 | 2 | ⊙ | 181 | >300 |
| experimental | | | | | | | | | |
| example | | | | | | | | | |
| Sixth | Application | Al2O3 | 0.3 | 5 | 0.5 | 2 | ⊙ | 170 | >300 |
| experimental | | | | | | | | | |
| example | | | | | | | | | |
| Seventh | Application | Al2O3 | 0.3 | 5 | 3 | 2 | ◯ | 165 | <200 |
| experimental | | | | | | | | | |
| example | | | | | | | | | |
| Eighth | Application | Al2O3 | 0.3 | 5 | 2 | 1 | ⊙ | 190 | <200 |
| experimental | | | | | | | | | |
| example | | | | | | | | | |
| Ninth | Application | Al2O3 | 0.3 | 5 | 2 | 0.5 | ⊙ | 195 | <100 |
| experimental | | | | | | | | | |
| example | | | | | | | | | |
| First | No | — | — | — | — | — | ⊙ | 200 | >300 |
| comparative | | | | | | | | | |
| example | | | | | | | | | |
| Second | No | — | — | — | — | — | ⊙ | 80 | <1 |
| comparative | | | | | | | | | |
| example | | | | | | | | | |

⊙: Excellent,
◯: Good

A pre-press of the negative active material layer 403 at the negative electrode 400 was 1.5 (ton·f/cm) in a line pressure, and room temperature (RT) was 25° C. The solid electrolyte layer 300 was directly coated on the negative active material layer 403 and dried, and the thickness thereof was 100 μm.

In the positive electrode 210, a specific capacity of the positive active material layer 213 was 200 (mAh/g), the positive active material was 85%, a loading level (L/L) was 20.56 (mg/cm²), a current density was 4.11 (mAh/cm²), the line pressure was 5.0 (ton·f/cm) during pre-pressurization, and a temperature was 120° C.

The negative electrode 400/solid electrolyte layer 300/positive electrode 210 were temporarily bonded.

Two rolls of a roll press had a diameter (ϕ) of 400×400 mm each, an effective length of 120 mm, a line pressure of 5.0 (ton·f/cm), and a temperature of 120° C. The elasticity layer 500 was acryl foam or polyurethane foam with a thickness of 300 μm and was applied for a charge/discharge evaluation. The initial capacity was 0.1 C-0.05 C charge and 0.1 C discharge, and the short circuit occurred at 0.33 C-0.1 C charge and 0.33 C discharge.

The first to ninth experimental examples were pressed with a roll press, and the first comparative example was an isotropic pressurization (500 MPa, 98° C., 30 min) such as warm isostatic pressurization (WIP) with a gasket. The second comparative example is pressed under the same conditions as the roll press. The second comparative example has a micro-short in the first charge, making it difficult to evaluate a normal charge and discharge.

In the first to ninth experimental examples, the sizes of the positive electrode 210 and the negative electrode 400 are the same, the NP ratio is set as 1.0, and the solid electrolyte layer 300, which is a separation layer between the negative electrode 400 and the positive electrode 210, may be uniformly pressed.

The first to ninth experimental examples apply a uniaxial roll press with a shear force, and the gasket 10 is applied to the edge of the positive electrode 210 to verify a normal charge and discharge and a long cycle-life. The first to ninth experimental examples suppress the same short circuit as the second comparative example.

The gasket 10 is composed of an oxide powder and a binder, and in one example, the powder size is 300 nm, and the binder is 5 wt % of PVDF-HFP which has low reactivity with sulfide electrolytes. The thickness t of the gasket 10 is 0.5 μm to 10 μm, and the width W1 is adjusted in the range of 0.5 mm to 2 mm.

The evaluation criteria for each condition are the solid electrolyte layer 300 pressure uniformity, the initial capacity at charge and discharge, and the time if a short circuit occurs during a cycle-life.

In the first to fourth experimental examples, the powder composition of the gasket 10 is changed, but equivalent characteristics are confirmed in terms of pressurization uniformity and if a short circuit occurs (i.e., insulating properties). In the fifth to seventh experimental examples the thickness t of the gasket 10 is varied where the pressurization uniformity deteriorates as the thickness t increases, and the initial capacity and the cycle-life also deteriorates compared to the baseline.

In the eighth and ninth experimental examples, the width W1 of the gasket 10 is reduced, and as the width W1 decreases, the initial capacity increases, but the cycle-life, on the contrary, deteriorates compared to the baseline. In other words, it is understood that as the width W1 of the gasket 10 becomes smaller, the amount of Li precipitation at the edge of the negative electrode 4100 increases, and the stress of Li to the solid electrolyte layer 300 increases, and thus the short-circuit time shortens.

In general, if the sizes of the positive and negative electrodes are not the same, it is impossible to uniformly pressurize the middle solid electrolyte layer by using a uniaxial pressing method. Additionally, if the sizes of the positive and negative electrodes are the same, there is a problem of short circuiting due to excessive Li precipitation and movement of Li ions at the edge of the negative electrode.

However, in the experimental examples of the present disclosure, the gasket 10 is applied between the positive electrode 210 and the solid electrolyte layer 300 even if the NP ratio is 1.0, thereby short circuiting does not occur even with the 1-axis roll press, and the solid electrolyte layer 300 may be uniformly pressurized.

By way of summation and review, because lithium ion batteries currently on the market use an electrolyte solution including a flammable organic solvent, there may be a possibility of overheating and fire if a short circuit occurs. In response to this, an all-solid-state rechargeable battery using a solid electrolyte instead of the electrolyte solution is being proposed.

By not using the flammable organic solvents, all-solid-state rechargeable batteries may greatly reduce the possibility of fire or explosion even if short circuit occurs. Therefore, these all-solid-state rechargeable batteries may greatly increase safety compared to lithium ion batteries which use the electrolyte solution.

An embodiment may provide a solid rechargeable battery that suppresses an electrical short circuit by forming an NP ratio of a negative electrode and a positive electrode functionally greater than 1.0 (NP ratio>1) while the sizes of the positive electrode and the negative electrode are the same.

In an embodiment, through the gasket being interposed on the edge between the solid electrolyte layer and the positive active material layer, even if the sizes of the positive and negative electrodes are the same, electrical short circuits between the positive and negative electrodes may be suppressed.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid-state rechargeable battery comprising:
a negative electrode;
a solid electrolyte layer stacked on the negative electrode;
a positive electrode, including a positive active material layer on a positive electrode current collector, stacked on the solid electrolyte layer; and
a gasket inserted at an edge to overlap the positive active material layer and between the positive active material layer and the solid electrolyte layer,
wherein the positive active material layer includes:
a high-density area corresponding to the gasket and compressed by an intrusion of the gasket, and
a low-density area inside the high-density area.

2. The all-solid-state rechargeable battery as claimed in claim 1, wherein the positive electrode current collector includes:
a low-intensity area corresponding to the high-density area, and
a high-intensity area inside the low-intensity area.

3. The all-solid-state rechargeable battery as claimed in claim 1, wherein:
the high-density area has a density of about 3.4 g/cm³ to about 3.6 g/cm³, and
the low-density area has a density of about 3.2 g/cm³ to about 3.4 g/cm³.

4. The all-solid-state rechargeable battery as claimed in claim 2, wherein:
an end of the positive electrode aligns with an end of the gasket, and
an end of the solid electrolyte layer protrudes further outward than the end of the positive electrode and the end of the gasket by a protrusion width.

5. The all-solid-state rechargeable battery as claimed in claim 2, wherein the positive active material layer and the gasket define a plane on the solid electrolyte layer.

6. The all-solid-state rechargeable battery as claimed in claim 5, wherein the positive active material layer and the gasket have a stepped structure.

7. The all-solid-state rechargeable battery as claimed in claim 1, wherein the gasket penetrates the solid electrolyte layer.

8. The all-solid-state rechargeable battery as claimed in claim 7, wherein an amount of a penetration of the gasket is about 20% or less of a thickness of the gasket.

9. The all-solid-state rechargeable battery as claimed in claim 8, wherein the gasket has a stepped structure with the positive active material layer, and a reverse stepped structure with the solid electrolyte layer.

10. The all-solid-state rechargeable battery as claimed in claim 1, wherein the gasket includes an oxide.

11. The all-solid-state rechargeable battery as claimed in claim 1, wherein:
a width of the gasket is greater than 0 and less than about 5 mm, and
a thickness of the gasket is greater than 0 and less than about 10 μm.

12. A manufacturing method of an all-solid-state rechargeable battery, the manufacturing method comprising:
pressing a positive electrode in which a positive active material layer is on a positive electrode current collector with a first roll press;
transferring a gasket to a surface of the positive active material layer with a second roll press;
punching the positive electrode to which the gasket is transferred with a flat plate;
stacking a negative electrode on a solid electrolyte layer;
stacking the solid electrolyte layer on the positive active material layer and the gasket; and
pressing the solid electrolyte layer with a third roll press.

13. The manufacturing method of the all-solid-state rechargeable battery as claimed in claim 12, wherein the first roll press pressurizes the positive active material layer with 50% of a total pressurization increasing a first adhesion between the positive active material layer and the gasket to be greater than a second adhesion between the gasket and a carrier film.

14. The manufacturing method of the all-solid-state rechargeable battery as claimed in claim 12, wherein the second roll press:
pressurizes a first area of the positive active material layer corresponding to the gasket to a high density, and
pressurizes a second area, which is inside the first area, to a lower density than the first area.

15. The manufacturing method of the all-solid-state rechargeable battery as claimed in claim 14, wherein the second roll press:
pressurizes a first response area of the positive electrode current collector to low intensity, and
pressurizes a second response area, which is inside the first response area, to a higher intensity than the first response area.

16. The manufacturing method of the all-solid-state rechargeable battery as claimed in claim 15, wherein the third roll press:
aligns ends of the positive electrode and the gasket with each other, and
causes an end of the solid electrolyte layer to protrude farther outward than the ends of the positive electrode and the gasket by a protrusion width.

17. The manufacturing method of the all-solid-state rechargeable battery as claimed in claim 15, wherein the third roll press forms the positive active material layer and the gasket to be on the same plane on the solid electrolyte layer.

18. The manufacturing method of the all-solid-state rechargeable battery as claimed in claim 17, wherein the third roll press further forms the gasket to protrude beyond the surface of the positive active material layer on the solid electrolyte layer and to penetrate the solid electrolyte layer.
